(19) United States
(12) Patent Application Publication
(10) Pub. No.: US 2026/0219039 A1
(43) Pub. Date: Jul. 30, 2026

(54) WIRELESS UNDERGROUND HORIZONTAL INCLINOMETER SYSTEM CAPABLE OF DETECTING CLAMPS BY USING PROXIMITY SWITCH

(71) Applicant: Yong Ho JEONG, Seoul (KR)

(72) Inventor: Yong Ho JEONG, Seoul (KR)

(21) Appl. No.: 19/141,123

(22) PCT Filed: Nov. 30, 2023
(86) PCT No.: PCT/KR2023/019503

§ 371 Date: Jun. 19, 2025

(30) Foreign Application Priority Data
Dec. 20, 2022 (KR) 10-2022-0179100
Apr. 11, 2023 (KR) 10-2023-0047531

(51) Int. Cl. G01C 9/06

(52) U.S. Cl. CPC G01C 9/06

(57) ABSTRACT

The present invention relates to a wireless underground horizontal inclinometer system and, in particular, to a wireless underground horizontal inclinometer system capable of detecting clamps by using a proximity switch, wherein the inclinometer system can: perform measurements at an exact position by automatically transferring a measurement sensor of the underground horizontal inclinometer to the exact position; transfer the sensor for automatically measuring underground horizontal displacement or vertical lowering of the inclinometer in a direction perpendicular or horizontal to the ground; and take the influence of the surrounding environment into account when performing measurements.

### TECHNICAL FIELD

The present disclosure relates to an underground horizontal inclinometer system. More specifically, the present disclosure relates to a wireless underground horizontal inclinometer system capable of performing measurement at an exact position by automatically transferring a measurement sensor of an underground horizontal inclinometer to an exact position, transferring a sensor for automatically measuring underground horizontal displacement or vertical lowering in a direction perpendicular or horizontal to the ground, and taking the influence of the surrounding environment into account when performing measurements. In particular, the present disclosure relates to a wireless underground horizontal inclinometer system capable of detecting clamps by using a proximity switch.

### BACKGROUND ART

In general, in the process of civil engineering works such as building construction or ground work, measurements for collecting various types of data are performed in order to ensure the safety of the construction and to enable efficient operation. Such data measurement and management is intended to perform safe, efficient, and economical construction by acquiring data on the conditions of factors that are difficult to accurately identify during planning and design stages of civil engineering works, such as earth pressure or stress coefficients of the ground, using various measurement devices, and by predicting behaviors by comparing and examining the data with the design data during the construction process, such as ground excavation, on the basis of the measured data.

Since it is very important to measure the horizontal displacement of the ground in areas such as the surroundings of excavation sites, slopes, and dams due to natural or artificial influences, data measurement items for construction management at civil engineering sites, as described above, and an inclinometer, which is one of measurement devices, are essentially used to measure changes in inclination.

In general, when performing foundation work for buildings such as apartments or high-rise buildings, inclinometer tubes are buried at regular intervals (for example, at intervals of 30 meters) around the construction site of the buildings at depths of 50 meters or 100 meters to measure whether the ground has lowered. Further, a cable-connected probe is inserted into the buried inclinometer tubes to measure whether the inclinometer tubes are deformed and lowered due to lowering of the surrounding ground.

Such a probe is configured to ascend and descend while a wheel rotates along a longitudinally formed guide groove of the inclinometer tube. The probe is installed at the end of a cable wound on a cable reel and an inclinometer sensor is installed on the probe side such that the inclinometer sensor periodically measures inclination values corresponding to lowering of the inclinometer tubes.

In the case of such an automatic underground inclinometer, repeated measurements at the same location over several months to several years are required. However, since automatic underground inclinometer devices of the related art use encoders or distance measurement sensors on a transfer wheel for depth measurement, there is a problem that accurate distance measurement is difficult due to bends (irregularities) at the connection parts of a guide hole, cable slip caused by water or oil, and low-frequency vibrations caused by earthquakes or vehicles.

Further, automatic underground inclinometer devices of the related art use a vertical transfer device that moves a measurement sensor assembly (or probe) in a direction perpendicular to the ground, and such a vertical transfer device transfers a probe using gravity, so no additional transfer device is required. However, in the case of a horizontal transfer device that transfers a probe in a direction horizontal to the ground, gravity cannot be used, so a separate transfer device is required. Further, repeated measurements must be performed at the same point, but since distance is measured using an encoder on a transfer wheel, there is a problem that it is difficult to measure accurate distances.

The applicant, in order to solve such problems, has proposed a technique to control movement of a probe in a more accurate manner by installing clamps at regular intervals on the cable used in an underground inclinometer device and measuring the number of clamps, in Korean Patent No. 10-245498 (Oct. 11, 2022) and Korean Patent Registration No. 10-2459574 (Oct. 24, 2022).

However, in the case of underground inclinometer devices or systems including Korean Patent No. 10-245498 (Oct. 11, 2022) and Korean Patent No. 10-2459574 (Oct. 24, 2022), they are installed at construction sites or carried around by individuals for measurement in most cases. Since the devices are large and heavy, there is a problem that managing and using the devices is inconvenient.

In particular, in the case of underground inclinometer devices of the related art including the aforementioned patent documents, a communication cable and a power supply cable are separately provided to the sensor unit installed on the probe to receive data from the probe, and as a result, the weight and capacity of the cables wound on a cable drum increase, which causes a problem that it becomes difficult for individuals to handle, especially when long-distance measurement is performed.

In addition, there was a problem that accurate measurement was difficult due to environmental vibrations around the installed underground inclinometer devices, such as vibrations caused by construction vehicle movement and construction activities.

Further, in underground inclinometer devices of the related art, a contact-type probe detection unit such as a plate spring is used to detect the underground position of the probe by clamps installed on the cable. However, such a contact-type probe detection unit is degraded and loses elasticity due to subzero temperatures and repetitive use, so there is a problem of decreased performance of the probe detection unit.

### PRIOR ART LITERATURES

### Patent Literature

Korean Patent No. 10-20125 (Feb. 28, 2011)

Korean Patent No. 10-245498 (Oct. 11, 2022)

Korean Patent No. 10-2459574 (Oct. 24, 2022)

### SUMMARY OF INVENTION

### Technical Problem

The present disclosure has been made in an effort to solve the problems described above, and an objective of the present disclosure is to provide a wireless underground horizontal inclinometer system capable of reducing the weight and volume of a cable.

Another objective of the present disclosure is to provide an underground horizontal inclinometer system with a structure that enables more precise underground horizontal inclinometer measurement by taking environmental factors such as vibrations at the installation site of the underground horizontal inclinometer system into account.

Another objective of the present disclosure is to provide an underground horizontal inclinometer system with a structure capable of solving problems caused by physical degradation of the contact type in contact-type underground horizontal inclinometer systems of the related art.

### Solution to Problem

In order to achieve the objectives described above, according to an aspect of the present disclosure,
a wireless underground horizontal inclinometer device for moving a probe coupled to a cable within a guide pipe to measure an inclination of the underground includes: a transfer unit configured to move the probe, which includes a measurement sensor, within a bored guide hole—the transfer unit includes a cable, clamps are installed at regular intervals on the cable, and an end of the cable is connected to an end of the probe; a control unit configured to control operation of the transfer unit and receive measured data from the measurement sensor; a first Bluetooth communication unit configured to receive measurement data from the probe by performing Bluetooth communication with the probe; and a clamp detection unit configured to detect the clamps installed on the cable, wherein the clamp detection unit is a proximity sensor installed in the guide hole and detects the presence of a clamp when the clamp approaches within a predetermined distance.

In the above aspect, the control unit performs time synchronization through Bluetooth communication with a control unit of the probe, and moves the probe from an initial depth to a final depth after the time synchronization, and when the final depth is reached, the probe performs measurement through a sensor in the probe at predetermined time intervals while moving from the final depth to the initial depth, and the control unit records a clamp detection time when a clamp is detected by the clamp detection unit.

Further, in any one aspect described above, the control unit receives data measured by the sensor from the probe through the Bluetooth communication after all measurements through the sensor in the probe are completed, and the control unit acquires data after a predetermined time from the clamp detection time as stabilized data.

Further, in any one aspect described above, the probe is provided with a ring-shaped cable connection portion, and the cable is connected to the ring-shaped cable connection portion; and a sheath and an internal material of the cable are made of non-metallic materials.

### Advantageous Effects of Invention

According to the present disclosure as described above, it is possible to provide a wireless underground horizontal inclinometer system that can reduce the weight and capacity of a cable and to enable more precise underground horizontal inclinometer measurements by considering environmental factors such as vibrations at the installation site of the underground horizontal inclinometer system. Further, according to the present disclosure as described above, by providing a non-contact type clamp detection unit, it is possible to solve the problem of performance degradation of the detection unit caused by deterioration of elastic members such as springs in a contact type.

### BRIEF DESCRIPTION OF DRAWINGS

FIG. 1A is a diagram illustrating an example of an underground horizontal inclinometer system according to the present disclosure;

FIG. 1B is a diagram illustrating the configuration of the main body of the underground horizontal inclinometer device;

FIG. 2 is a diagram illustrating the internal configuration of the main body of the underground horizontal inclinometer device;

FIG. 3A is a diagram illustrating the configuration of a cable used in the underground horizontal inclinometer device;

FIG. 3B is a diagram illustrating the operation of a clamp detection unit for detecting clamps;

FIG. 4 is a diagram illustrating an example of a drum-side gear unit in the underground horizontal inclinometer device according to the present disclosure;

FIG. 4A is a diagram illustrating the configuration of a cable applicable to the underground horizontal inclinometer device according to the present disclosure;

FIG. 5 is a diagram illustrating the configuration of a control unit of a vertical underground horizontal inclinometer and a control unit of a probe;

FIG. 6 is a diagram illustrating the configuration of each control unit in the horizontal underground horizontal inclinometer device;

FIG. 7 is a flowchart illustrating an operation flow between the main body control unit and the probe control unit in the horizontal inclinometer device;

FIG. 8 is an explanatory diagram illustrating data acquisition through time synchronization;

FIG. 9 is a schematic diagram illustrating a configuration for charging a battery provided in the probe in the horizontal underground horizontal inclinometer device;

FIG. 10 is a diagram illustrating in more detail the configuration of the charging terminal of the charging dock and the charging terminal of the battery in the battery charging configuration of FIG. 9;

FIG. 11 is a schematic diagram illustrating a change in the weight of a cable according to an embodiment of the present disclosure; and

FIG. 12 is a diagram illustrating a change in the connection structure between the probe and the cable according to an embodiment of the present disclosure.

### DESCRIPTION OF EMBODIMENTS

Specific structural and functional description about embodiments according to the concept of the present disclosure disclosed herein is exemplified only to describe the embodiments according to the concept of the present disclosure, and the embodiments according to the concept of the present disclosure may be implemented in various ways and are not limited to the embodiments described herein.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but modifications, equivalents, and substitutions are included in the scope and spirit of the present disclosure. Hereafter, embodiments are described in detail with reference to the accompanying drawings. However, the scope of the present disclosure is not limited to the embodiments.

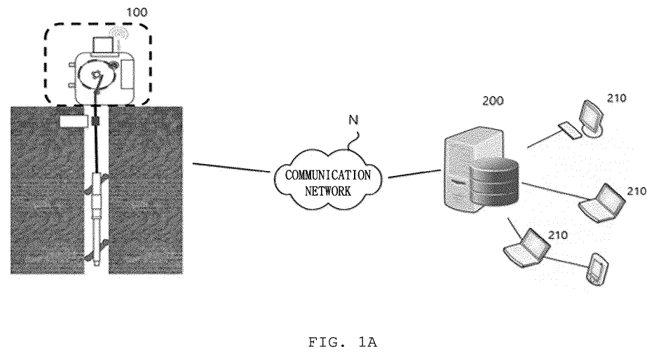

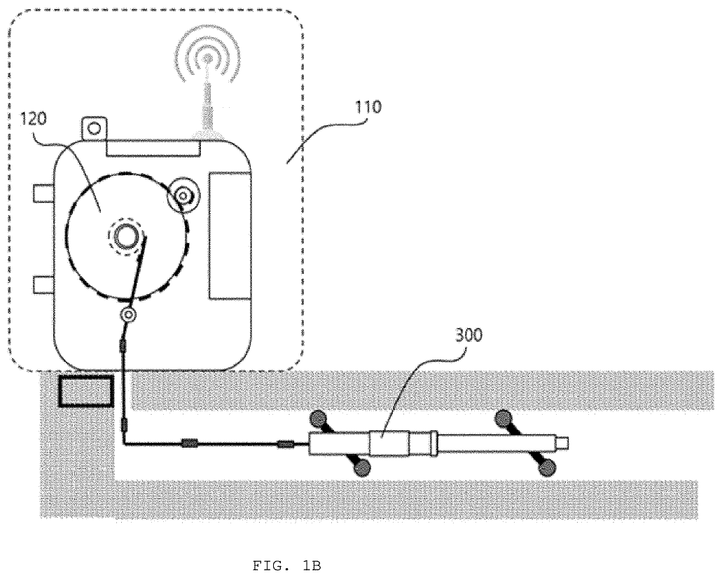

FIG. 1A is a diagram illustrating an example of an underground horizontal inclinometer system according to an embodiment of the present disclosure. As shown in FIG. 1A, an underground horizontal inclinometer system 10 according to the present disclosure includes an underground horizontal inclinometer device 100 and a database server 200, and the underground horizontal inclinometer device 100 and the database server 200 are connected to each other via a communication network or a network N.

The communication network N may be any one of a wired communication network and a wireless communication network, or a combination thereof. The wired communication network may include a Local Area Network (LAN), a Wide Area Network (WAN), and a Value Added Network (VAN). The wireless communication network may include a Personal Area Network (PAN), a mobile radio communication network (for example, Global System for Mobile communications (GSM), International Mobile Telecommunication (IMT-2000), Code Division Multiple Access (CDMA-2000), Wideband Code Division Multiple Access (W-CDMA), Long Term Evolution (LTE) communication), Wireless Broadband Internet (Wibro), Mobile WiMAX, and High Speed Downlink Packet Access (HSDPA)), or a satellite communication network.

The underground horizontal inclinometer device 100 is configured to transmit measurement data to the database server 200 though the network N, and the database server 200 is configured to store the measurement data in its own database and provide the measurement data to a client terminal 210 connected to the database server 200 upon request from the client terminal 210.

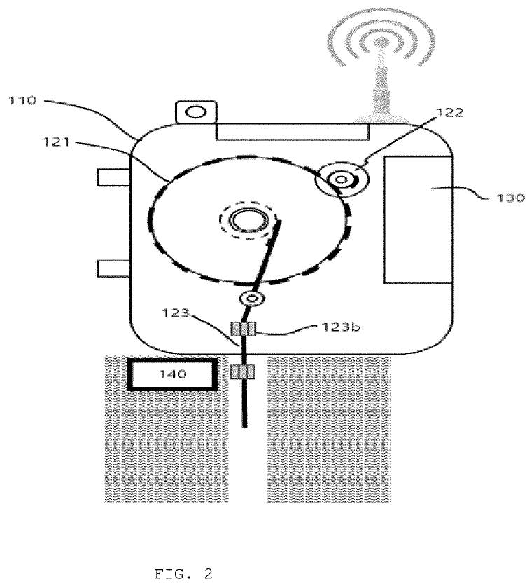

FIG. 1B is an explanatory diagram for describing the structure of the underground horizontal inclinometer device 100. As shown in FIG. 1B, the underground horizontal inclinometer device 100 includes a main body 110 exposed above the ground and a probe or a measurement sensor assembly 300 positioned in a bored hole or in a guide pipe disposed in the bored hole. The main body 110 includes a transfer unit that moves the probe 300 upward or downward in a direction perpendicular to the ground within the bored hole, or moves the probe 300 forward and backward in a direction horizontalto the ground within the bored hole, and a control unit that controls the operation of the transfer unit and simultaneously determines and digitizes an inclination according to depth on the basis of data measured from the probe. The configuration of the main body of the underground horizontal inclinometer device 100 will be described in more detail below with reference to FIG. 2.

FIG. 2 is a diagram schematically showing the internal configuration of the main body 110 of the underground horizontal inclinometer device 100. As shown in FIG. 2, the main body 110 of the underground horizontal inclinometer device 100 includes a transfer unit 120 for moving the probe; a control unit 130 for controlling the transfer operation of the transfer unit 120 and the operation of the measurement sensor; and a clamp detection unit 140 for detecting clamps attached to a cable. When the probe is moved forward and backward in the horizontal direction, the transfer unit 120 may further include a direction switching unit 124.

The transfer unit 120 includes a cable drum 121 into which the cable is wound, and a drive motor 122 coupled to the cable drum 121 and operating to rotate the cable drum 121. The drive motor 122 is a bidirectional motor capable of rotating in both directions so that the cable can be wound and unwound, and the drive motor 122 may further include a reducer (not shown) for maintaining tension of the cable when the probe is moved in a direction horizontal to the ground. Since the cable or wire 123 wound around the cable drum 121 is unwound from or wound into the cable drum 121 depending on the rotation direction of the drive motor 122, the measurement sensor or probe coupled to the end 123a of the cable 123 can perform movement operations (upward, downward, forward, and backward) within the hole bored in the ground or within a guide pipe inside the hole.

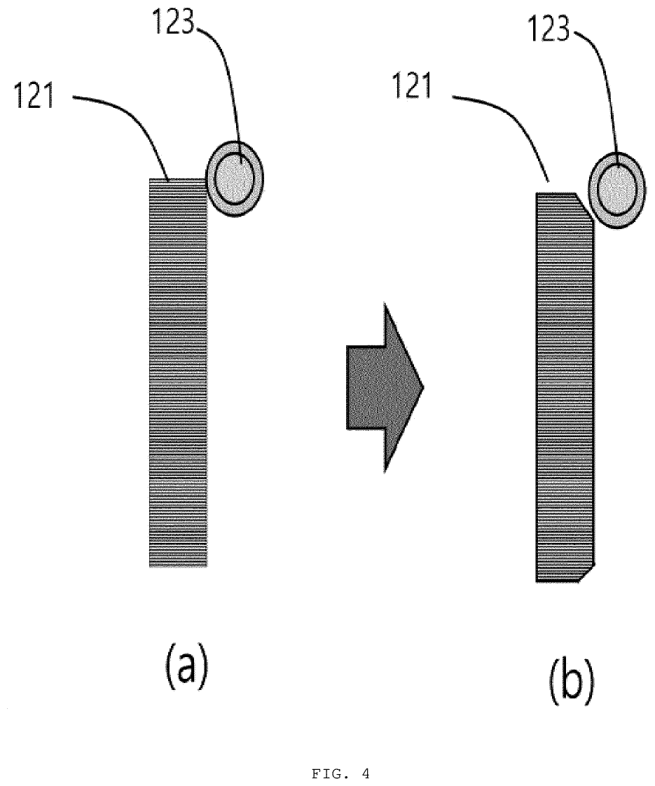

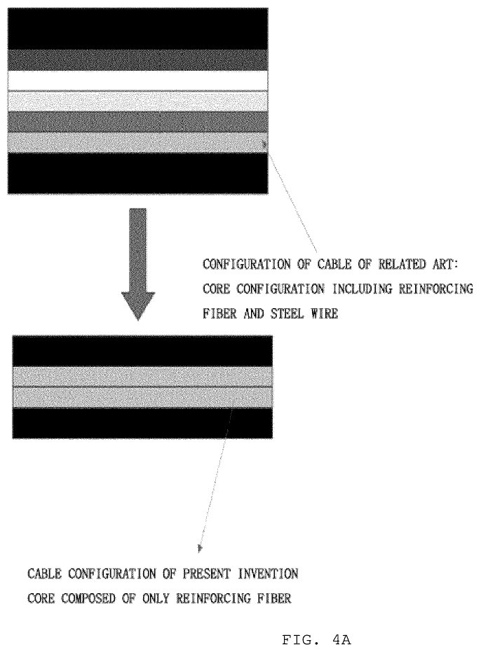

Further, when the cable 123 is wound in the cable drum 121, a clamp or the cable often gets caught on gear teeth, which may cause a positional error of the probe. In the present disclosure, in order to prevent the cable from getting caught while being wound into the cable drum 121 as described above, the inner surface of the gear teeth on the inner surface of the drum, into which the cable is wound, is machined to be inclined as shown in FIG. 4 to solve this problem.

Further, the drive motor 122 may be configured as a vibration device that generates vibration by continuously generating forward and reverse rotation signals under the control of the control unit 130, which will be described later. The vibration generated from the drive motor 122 can be detected by an acceleration sensor for measuring inclination in the sensor unit of the probe via the cable 123 and transmitted to an MCU (or a probe control unit). Although in the present embodiment, vibration is proposed to be generated through the drive motor 122, the present disclosure is not limited thereto, and a separate vibration generator capable of transmitting vibration to the probe 300 via the cable 123 may be additionally installed. The control of probe measurement using vibration will be described later.

The direction switching unit 124 may be configured as a rotating roller member or a rotating drum installed directly below the cable drum 121, and functions to extend the cable 123, which extends vertically from the cable drum 121, in a horizontal direction. When the direction switching unit 124 is employed, a tension sensor for detecting the tension of the cable in the horizontal direction may be further installed in the direction switching unit 124, and the control unit controls the winding or unwinding speed of the cable through the motor while maintaining the tension of the cable detected by the tension sensor constant.

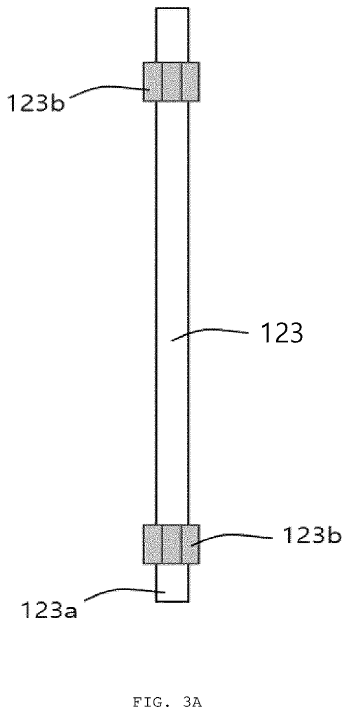

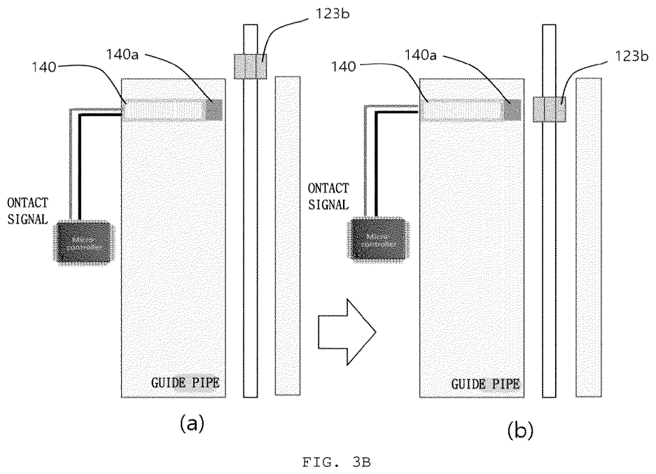

The clamp detection unit 140 is configured to identify the clamps by determining the presence or absence of contact with the clamps 123b. Specifically, FIG. 3A is a diagram exemplarily illustrating the structure of the cable 123 that is wound into the cable drum 121 and FIG. 3B is a diagram for describing the operation of the clamp detection unit 140 that detects the clamps 123b. As shown in FIG. 3A and FIG. 3B, a plurality of clamps 123b is installed on the cable 123. The clamps 123b are provided to ascertain the exact position (or height) of the measurement sensor or probe within the boredhole. The clamps 123b are installed on the cable at predetermined intervals, for example, preferably at intervals of 0.5 m. By arranging the clamps 123b at predetermined intervals, the control unit 130 can place the probe at an exact position within the boredhole and ascertain the exact position of the probe on the basis of the number and position of the clamps 123b detected by the clamp detection unit 140.

The clamp detection unit 140 includes an inductive proximity sensor 140a. The inductive proximity sensor 140a detects the presence or absence of conductive objects (e.g., metal), and the detection range varies depending on the type of the metal to be detected. The inductive proximity sensor 140a operates using a high-frequency magnetic field generated by a coil in an oscillation circuit. When a conductive target approaches the magnetic field, an induced current or eddy current is generated, which causes an opposing magnetic field and effectively reduces the inductance of the inductive sensor.

The inductive proximity sensor can operate in two ways. In the first operation method, when a target approaches the sensor, the flow of induced current increases, which increases the load of the oscillation circuit, whereby oscillation is dampened or stopped. The inductive proximity sensor can detect this change in the oscillation state through an amplitude detection circuit and output a detection signal. In the second operation method, instead of using the oscillation amplitude depending on the presence or absence of a conductive target, a change in frequency may be used. When a non-ferrous metal target such as aluminum or copper approaches the sensor, the oscillation frequency increases, and when a ferrous metal target such as iron or steel approaches, the oscillation frequency decreases. That is, when the oscillation frequency changes in proportion to a reference frequency, the output state of the sensor changes. As shown in FIG. 3V, as the clamp 123b approaches the inductive proximity sensor 140a, a contact signal is generated from the sensor, and as the generated contact signal is input to a microprocessor, the presence of the clamp can be determined.

The clamp 123b is made of conductive metal such as copper, aluminum, or stainless steel, or other materials coated with a superconductor, and the inside of the cable is composed only of reinforced fiber. This, as shown in FIG. 4A, has the effect of reducing cable manufacturing costs compared to the cables of the related art, which are manufactured using metals such as iron to increase tensile strength.

As shown in FIG. 3B, when the cable 123 passes through the clamp detection unit 140, since no metal is present inside the cable 123, the clamp detection unit 140 remains electrically open, and induced current is not generated. However, as shown in (b) of FIG. 3B, when the metallic clamp 123b attached to the sheath of the cable 123 passes through the clamp detection unit 140, the inductive proximity sensor of the clamp detection unit 140 reacts with the metallic clamp 123b, thereby generating an induced current, and the clamp detection 140 detects this and determines the presence of the clamp.

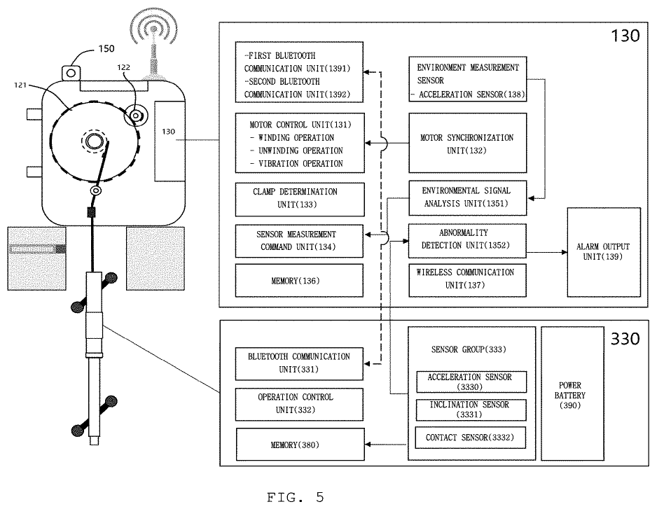

FIG. 5 is a diagram illustrating the internal structures of a control unit 130 of the main body 110 and a control unit 330 of the probe in an underground horizontal inclinometer device installed in the vertical direction. As shown in FIG. 5, the control unit 130 of the main body includes: a motor control unit 131 that controls the rotational speed and rotational direction of a first drive motor 122 coupled to a first cable drum 121 to rotate the first cable drum 121; a first Bluetooth communication unit 1391 that performs Bluetooth communication with a Bluetooth communication unit 331 installed in the probe 300 and receives measurement data measured by the probe 300; a motor synchronization unit 132 that synchronizes operations between drive motors when a plurality of drive motors are used; a clamp determination unit 133 that counts the number of clamps detected from the clamp detection unit 140; a sensor measurement command unit 134 that instructs the measurement sensor in the probe to perform measurement when it is determined by the clamp determination unit 133 that a clamp has been detected; an abnormality detection unit 1352 that receives values measured by the sensor and determines whether there is any an abnormality; a memory 136 in which the measurement data is stored; and a wireless communication unit 137 that communicates with an external database server 200.

Further, the main body 110 is further provided with an acceleration sensor 138 for receiving environmental factors of the place where the horizontal inclinometer device is installed, particularly vibrations, the environmental factors measured by the acceleration sensor 138 are transmitted to an environmental signal analysis unit 131, the environmental signal analysis unit 131 checks whether a measured environmental signal is within a predetermined range (threshold range), and when the environmental signal is within the threshold range, the environmental signal analysis unit 131 transmits this to the sensor measurement command unit 134, and the sensor measurement command unit 134 transmits a final measurement command to an operation control unit 332 of the control unit of the probe 300.

The motor control unit 131 is configured to control the rotation direction and rotation speed of a motor, which determines the moving direction (forward, backward) and moving speed of the cable 123. Preferably, the moving speed of the cable is within a range of 5 cm/sec to 30 cm/sec in order to minimize the detection error of the clamp. Further, in addition to controlling the moving direction and moving speed as described above, the motor control unit 131 can also operate to generate vibration. Vibration generated using a motor can generate a vibration signal with a specific pattern by rapidly switching the motor between the forward (advance) and reverse (retreat) directions. The generated vibration signal with a specific pattern is transmitted to the probe 300 through the cable, and the operation control unit 332 of the probe 332 may start measurement using the measurement sensors upon receiving the vibration signal as a trigger signal.

The motor synchronization unit 132 is used when it is desired to move the probe 300 horizontally in the ground, as will be described below, and the motor synchronization unit 132 is configured to synchronize the operations of the first driving motor 122 and the second driving motor 1220. For example, the motor synchronization unit synchronizes the first and second motors such that when the first driving motor 122 starts an unwinding operation, the second driving motor 1220 starts a winding operation within several milliseconds (ms), or when the first driving motor 122 starts a winding operation, the second driving motor 1220 starts an unwinding operation within several milliseconds (ms).

The clamp determination unit 133 determines whether a detection signal detected by the clamp detection unit 140 is caused by a clamp or by another factor (for example, metallic substances adhered to the cable surface), and when it is determined that a clamp has been detected, the clamp determination unit 133 counts the number of clamps and transmits the clamp detection signal to the sensor measurement command unit 134. Because clamps are installed on the cable at predetermined regular intervals, the control unit (clamp determination unit) can position the probe at an exact location within the guide tube by counting the number of clamps. Therefore, by positioning the probe at a specific location on the basis of the number of clamps and performing measurement, positioning errors caused by slippage and the like in underground inclinometers that perform measurement using an encoder installed on a transfer wheel or a sensor guide roller can be prevented.

Inside the main body 110, an environment measurement sensor, that is, an environment measurement sensor 130 that can detect surrounding environmental vibrations, such as an acceleration sensor 138, is provided. The environment measurement sensor 138 is used to provide an accurate measurement timing to prevent measurement errors caused by external vibrations during measurement by the probe 300. A vibration signal measured by the environment measurement sensor 138 is transmitted to the environmental signal analysis unit 1351, the environmental signal analysis unit 131 determines the magnitude of the measured external vibration, and when the magnitude is within a predetermined range, the environmental signal analysis unit 131 transmits this to the sensor measurement command unit 134, and the sensor measurement command unit 134 transmits a measurement command to the probe 300 to instruct the start of measurement.

The abnormality detection unit 1352 operates to analyze and process signals measured by the sensors of the probe. The abnormality detection unit 1352 monitors the values measured by the measurement sensor 333 and determines whether abnormal displacement has occurred. In the case of underground inclinometers of the related art, measured data is compared and reviewed with an expected displacement amount in the design and used to estimate and determine the ground relaxation area, safety of temporary structures, and damage influence zone. However, in the present disclosure, an initial measurement value is stored in the memory 136, and thereafter a current measurement value is compared with the initial measurement value to calculate the magnitude of the displacement amount, and when the magnitude exceeds a management criterion, an alarm is issued and a remeasurement process is performed. The remeasurement process is performed by narrowing the measurement interval stepwise in accordance with the management criteria in measuring, and by widening the measurement interval again when the amount of change stabilizes. For example, when a first management criterion is exceeded, one additional measurement is performed; when a second management criterion is exceeded, measurements are performed at half the previous measurement interval after one additional measurement; and when a third management criterion is exceeded, measurements are continuously performed.

Therefore, when a hazardous situation such as ground relaxation progresses, a remeasurement logic is automatically performed and it becomes possible to check the ground condition more accurately and promptly, whereby it becomes possible to rapidly respond to the hazard.

Further, the abnormality detection unit 1352 includes, in addition to the remeasurement instruction as described above upon detecting an abnormal displacement, an alarm output function and/or an SMS notification function using an alarm output unit 139. The alarm output unit 139 functions to immediately transmit an alarm through a speaker installed in the horizontal inclinometer device 100 or to transmit an SMS message to a predetermined administrator terminal or server, on the basis of a command from the abnormality detection unit 1352. For this purpose, alarm broadcasts and SMS messages corresponding to event types may be stored in advance in the memory 136.

Various forms of wireless communication protocols for communication with an external server 200 can be applied to the communication unit 137, and short-range communication methods such as RFID, infrared (IR) communication, Bluetooth, Zigbee, UWB (Ultra WideBand), Wi-Fi, RF communication, LoRa communication, or mobile communication networks such as LTE can be applied.

Further, the main body 110 of the underground horizontal inclinometer device 100 may further include an external imaging camera 150. The external imaging camera 150 operates to capture a surrounding environment under a command from a control unit to be described below, and more specifically, and is configured to transmit images captured by the external camera along with measurement data information to a database server 200 when a displacement amount measured by the probe exceeds a management criterion, and an administrator can review the external environment of the underground horizontal inclinometer device together with the remeasurement data, which helps the administrator identify the cause of the abnormal displacement. Although the external camera 150 is described as operating only when abnormal displacement is detected, the present disclosure is not limited thereto and may be configured to capture images of the surrounding environment at predetermined time intervals even when the measured displacement amount is within the management criterion. Preferably, the external camera 150 is configured as a 360-degree camera capable of capturing the surrounding environment or may include a plurality of cameras having predetermined fields of view.

In this manner, when the external camera 150 is provided, the abnormality detection unit 1352 commands the external camera 150, which is attached to the main body 110, to capture the external environment of the underground horizontal inclinometer device 100 when abnormal displacement is detected by the underground sensor as described above. In this case, the control unit of the main body is configured to transmit the images captured by the external camera 150 together with remeasurement data information to the database server 200 when the measured displacement exceeds the management criterion.

Meanwhile, the probe 300 includes a Bluetooth communication unit 331 for performing Bluetooth communication with the main body, an operation control unit 332 for controlling the operation of a sensor group 333, a sensor group 333 including an inclination sensor for measuring underground inclination, a contact sensor, and an angular velocity sensor, a power battery 390 for independently supplying DC power to the probe 390, and a memory 380 in which the measured data is stored.

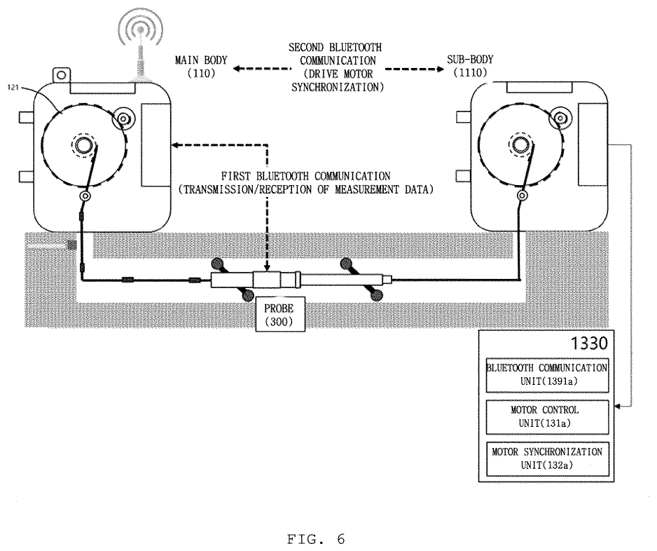

FIG. 6 is a diagram illustrating the configuration of an underground inclinometer device that moves the probe 300 in the horizontal direction using the main body 110 and the sub-body 1110 of the structure described in FIG. 5. As shown in FIGS. 5 and 6, the main body 110 includes a first Bluetooth communication unit 1391 and a second Bluetooth communication unit 1392. The control unit 130 of the main body 110 communicates with the probe 300 using the first Bluetooth communication unit 1391, while communicating with a Bluetooth communication unit 1391a of the sub-body 1110 using the second Bluetooth communication unit 1392.

The sub-body 1110 may be designed and manufactured with the same structure as the main body 110. In this case, it is also possible to provide a mode switch to switch between the main body 110 and the sub-body 1110. However, as shown in FIG. 6, the sub-body 1110 may also be designed and manufactured to include a minimum set of components, such as the Bluetooth communication unit 1391a communicating with the main body 110, the motor control unit 131a for unwinding or winding the cable through the cable drum inside the sub-body 1110, and the motor synchronization unit 132a for synchronizing with the rotation direction of the drive motor of the main body 110.

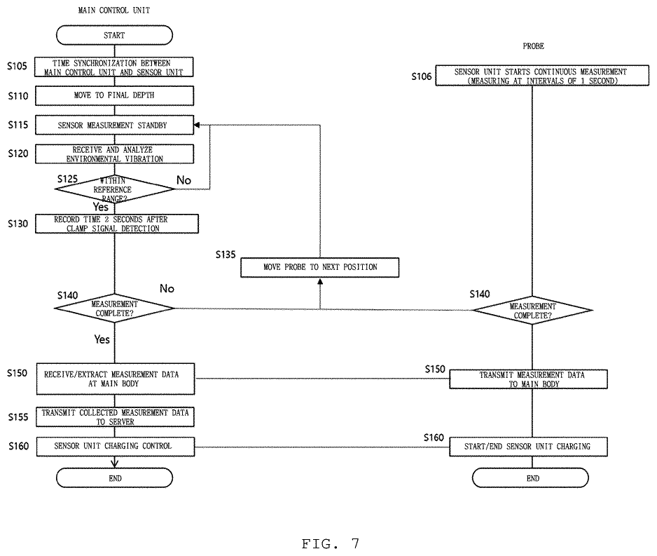

FIG. 7 is a diagram illustrating the flow of control operation between the main body control unit 130 and the probe control unit 330 in a state where the underground horizontal inclinometer device described above is disposed to move the probe in a direction perpendicular to the ground as shown in FIG. 5.

As shown in FIG. 7, prior to step S110, the main body and the probe are first connected to each other via Bluetooth communication (first Bluetooth communication). After the main body and the probe are connected to each other via Bluetooth communication, in step S105, the control unit of the main body performs time synchronization with the probe control unit. This is because vibration generated by momentary rotation of the motor is transmitted from the vibration generator to the probe control unit or the sensor unit as a measurement start signal, but there is a problem that construction vibration occasionally overlaps with a measurement signal, so erroneous data may be included in measurement data. To solve this problem, the present disclosure starts measurement on the basis of time synchronization between the main body and the probe. Measurement by the sensor unit of the probe is performed at predetermined time intervals, for example, at 1-second intervals (or multiples thereof) while the probe descends to the final depth (step S106), whereby the probe moves to the final depth through this process (step S110). After the probe has moved to the final depth, the main body, in step S110, moves the sensor of the probe to the measurement position. In the subsequent step S115, when the probe has completed moving to a first measurement position, the control unit 130 of the main body instructs the control unit 330 of the probe to wait for measurement, and, in step S120, the control unit 130 of the main body receives and analyzes environmental vibration signals from the Environment measurement sensor (or acceleration sensor) 138.

In step S125, the control unit 130 of the main body determines whether the analyzed environmental vibration value is within a reference range, and when it is within the reference range (i.e., Yes), the process proceeds to step S130, and the measurement by the probe is continuously started. Further, the control unit 130 of the main body monitors the presence of a clamp in step S130 while rewinding up the cable from the final depth. Upon detection of the clamp, the control unit stops the cable at each depth and records the time 2 seconds after the clamp signal is detected, and then moves the clamp to the next position in step S135. The probe performs measurement of necessary parameters during movement using the inclination sensor, angular velocity sensor, contact sensor, etc., and stores the measured data in its own memory.

After the measurement at the first position is completed, the control unit 130 of the main body checks whether there is a next measurement point. If there is a next measurement point, the process returns to step S115, moves the sensor to the next measurement position, and repeats steps up to step S140 so that measurement is performed at the next position.

After the measurement at all measurement points is completed in step S140, the process proceeds to step S145, in which the control unit 330 of the probe 300 transmits the measured and stored data to the control unit 130 of the main body via Bluetooth communication, and, in the next step S150, the control unit 130 of the main body receives the measurement data. The main control unit 130 wirelessly receives the measured data from the sensor unit of the probe, classifies and stores only the measurement data taken 2 seconds (or 1 second) after the clamp detection time on the basis of the clamp detection time recorded by the main measuring unit, and transmits the data to a remote location.

In an embodiment of the present disclosure, the main control unit continuously checks data of the vibration sensor to check whether construction vibrations occur during probe measurement, and when vibration during measurement exceeds a predetermined vibration level, it continues to wait, and if it is below that level, it moves after 2 seconds (or 1 second). Therefore, the main control unit determines the time after 2 seconds (or 1 second) as the data acquisition state and collects measurement data of that time after measurement is completed. Accordingly, the main control unit can extract only stable data from vibrations occurring at the measurement site through time synchronization with the probe control unit, whereby the reliability of measurement data can be ensured.

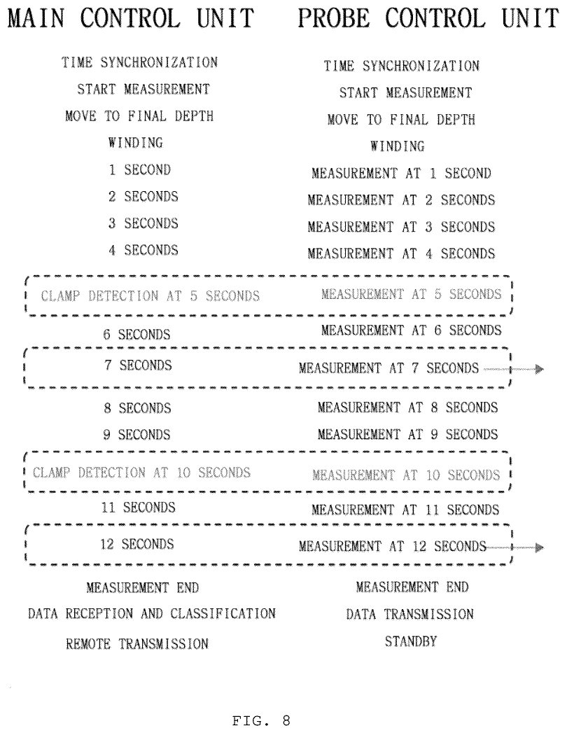

FIG. 8 is a flowchart illustrating an example of clamp detection and data measurement according to time synchronization in the operation flow between the main control unit and the probe control unit shown in FIG. 7. As shown in the figure, although first clamp detections occurred at 5 seconds and 10 seconds, the actual data is configured to be collected from the data measured 2 seconds later at 7 seconds and 12 seconds, whereby it is possible to extract only stable data unaffected by vibrations.

FIG. 8 is a diagram illustrating the flow of control operation between the sub-body control unit 1330 and the control unit 330 of the probe in a state where the underground horizontal inclinometer device described above is disposed to move the probe under the ground in a direction horizontal to the ground as shown in FIG. 6.

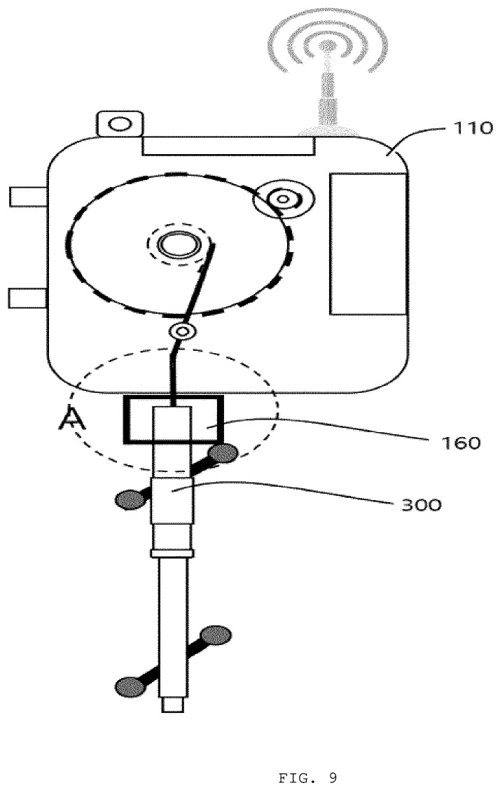

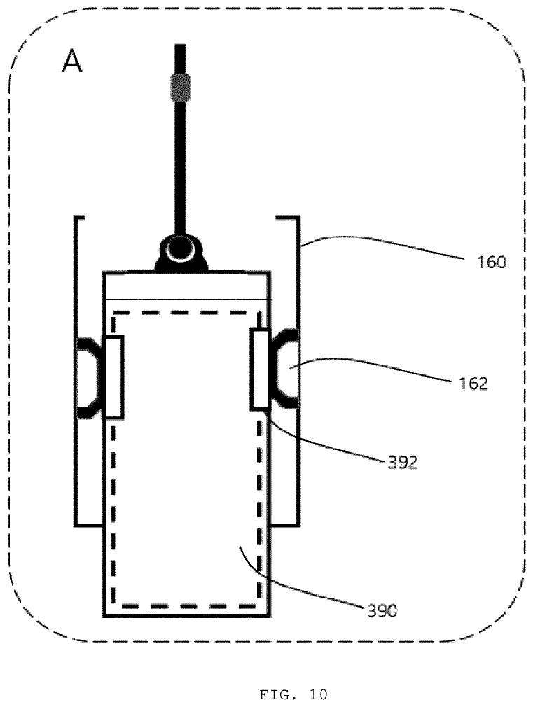

FIG. 9 is a diagram illustrating the charging form of the battery 390 of the probe 300 and FIG. 10 is an enlarged view of the “A” area in FIG. 9. As shown in FIG. 9 and FIG. 10, in an embodiment of the present disclosure, the probe 300 is configured to receive necessary power by its own battery 390, unlike the related art. The battery 390 supplies power for the probe 300 to measure inclination using a sensor and to transmit and receive data, and it is necessary to charge the battery when using it. The battery 390 may be provided at the rear of the probe 300, that is, near the connection with the cable. The battery 390 may be detachably fixed to the body of the probe 300, and charging terminals 392 for charging the battery during use of the probe 300 are provided in a housing surrounding the battery 390.

For charging the battery through the charging terminals 392, a charging dock 160 for battery charging is provided at the lower end of the main body 110, for example, below the clamp detection unit 140. As shown in FIG. 9, charging terminals 162 for battery charging are provided on both sides of the charging dock 160, and when the probe 300 is positioned at a charging position, charging starts.

Specifically, the control unit 130 of the main body 110 checks the status such as short circuit when the charging terminals 392 of the probe 300 are coupled to the charging terminals 162 of the charging dock 160 and then performs charging in a normal state.

Further, the control unit of the probe 300 is exposed to underground moisture at the charging terminals 392, so there are concerns about circuit damage due to short circuits. The charging terminals are activated only when charging with the charging dock of the main body is confirmed, and during underground sensor measurement, the charging terminal circuit remains electrically disconnected and inactive. The probe 300 and the main body 110 check the charging status (completed, discharged) immediately after the final measurement is completed (for example, after step S140 in FIG. 7) and determine whether to charge.

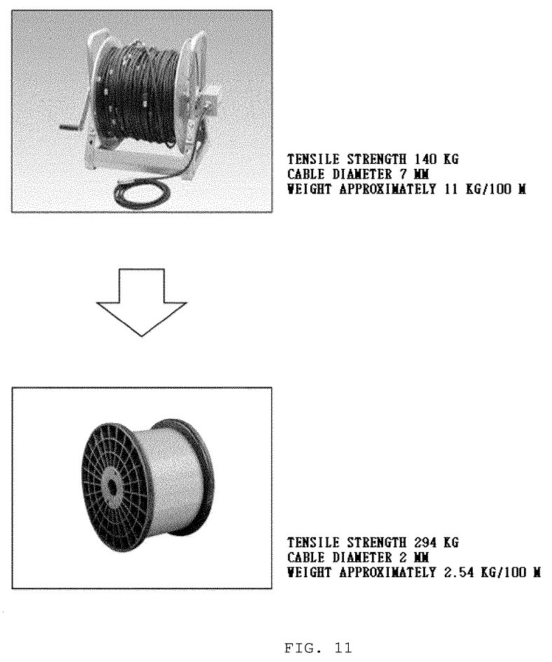

FIG. 11 is a diagram illustrating a comparison between a cable used in the related art and a cable used in the underground horizontal inclinometer device according to an embodiment of the present disclosure. As shown in FIG. 4A and FIG. 11, in the case of the cable used in an underground horizontal inclinometer device of the related art, in addition to a stainless wire for transferring a probe, a communication cable for transmitting and receiving communication signals and a power cable for supplying power are required. However, according to an embodiment of the present disclosure, a communication cable and a power cable for supplying power become unnecessary, it is possible to achieve an effect of significantly reducing the weight of the cable and increasing tensile strength of the cable.

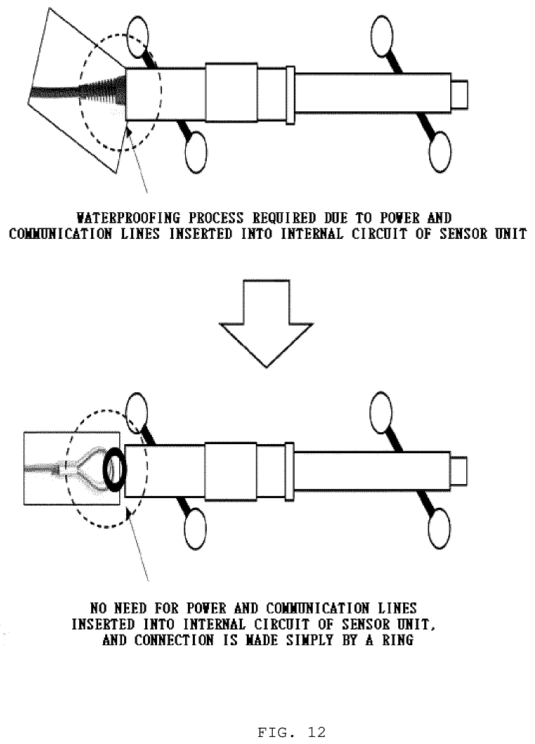

Further, as shown in FIG. 12, in the case of a cable used in an underground horizontal inclinometer device of the related art, it is required to connect power and communication lines to the circuit inside the sensor unit of a probe, whereby an additional configuration for preventing cable disconnection at a connection portion between the cable and a probe are essentially required, including waterproofing treatment at the connection portion. However, according to an embodiment of the present disclosure, since it is only required to transmit vibration through a stainless wire, a cable is simply connected using a ring, and therefore, waterproofing or disconnection prevention treatment as in the related art is no longer necessary.

Further, the devices described above can be achieved by hardware components, software components, and/or a combination of hardware components and software components. For example, the system and components described in the embodiments by one or more common computers or computers for specific purposes, such as a processor, a controller, an ALU (arithmetic logic unit), a digital signal processor, a microcomputer, an FPGA (field programmable gate array), a PLU (programmable logic unit), a microprocessor, or any devices that can execute instructions and give responses. A processing device can operate an operating system (OS) and one or more software applications that are executed on the operating system. Further, the processing device can access, store, operate, process, and create data in response to execution of software. For the convenience of understanding, one processor may be used, but those skilled in the art can understand that the processor may include a plurality of processing elements and/or a plurality of types of processing elements. For example, the processing device may include a plurality of processors, or one processor and one control unit. Further, other processing configurations such as parallel processors are also possible.

Software can include computer programs, codes, instructions, or a combination of one or more of them, and a processor device may be configured to operate in a desired way or processors may be configured individually or collectively. Software and/or data may be analyzed by processing devices or may be embodied on any types of machines, components, physical devices, virtual equipment, computer storage media or devices to provide commands or data to the processing devices. Software may be distributed to computer systems connected through a network and stored or executed in the distributed way. Software and data can be recorded on one or more computer-readable recording media.

The method according to an embodiment may be implemented in a program that can be executed by various computers and may be recorded on computer-readable media. The computer-readable media may include program commands, data files, and data structures individually or in combinations thereof. The program commands that are recorded on the media may be those specifically designed and configured for the present invention or may be those available and known to those engaged in computer software in the art. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter etc.

Therefore, other implements, other embodiments, and equivalents to the claims should be construed as being included in the following claims.

### REFERENCE SIGNS LIST

100: Underground horizontal inclinometer device
200: Database server
110: Main body
300: Probe
120: Transfer unit
130: Control unit
140: Clamp detection unit
150: External imaging unit
123: Cable
123b: Clamp

1. A wireless underground horizontal inclinometer device for moving a probe coupled to a cable within a guide pipe to measure an inclination of the underground, the wireless underground horizontal inclinometer device comprising:
a transfer unit configured to move the probe, which includes a measurement sensor, within a bored guide hole-the transfer unit includes a cable, clamps are installed at regular intervals on the cable, and an end of the cable is connected to an end of the probe;
a control unit configured to control operation of the transfer unit and receive measured data from the measurement sensor;
a first Bluetooth communication unit configured to receive measurement data from the probe by performing Bluetooth communication with the probe; and
a clamp detection unit configured to detect the clamps installed on the cable,
wherein the clamp detection unit is a proximity sensor installed in the guide hole and detects the presence of a clamp when the clamp approaches within a predetermined distance.

2. The wireless underground horizontal inclinometer device of claim 1, wherein the control unit performs time synchronization through Bluetooth communication with a control unit of the probe, and moves the probe from an initial depth to a final depth after the time synchronization, and when the final depth is reached, the probe performs measurement through a sensor in the probe at predetermined time intervals while moving from the final depth to the initial depth, and
The control unit records a clamp detection time when a clamp is detected by the clamp detection unit.

3. The wireless underground horizontal inclinometer device of claim 2, wherein the control unit receives data measured by the sensor from the probe through the Bluetooth communication after all measurements through the sensor in the probe are completed, and
The control unit acquires data after a predetermined time from the clamp detection time as stabilized data.

4. The wireless underground horizontal inclinometer device of claim 2, wherein the probe is provided with a ring-shaped cable connection portion, and the cable is connected to the ring-shaped cable connection portion; and
a sheath and an internal material of the cable are made of non-metallic materials.
